(19) United States
(12) Patent Application Publication
(10) Pub. No.: US 2004/0014887 A1
(43) Pub. Date: Jan. 22, 2004

(54) Polycarbonate and acrylonitrile-butadiene-styrene polymeric blends with improved impact resistance

(76) Inventor: Coreen Y. Lee, Kennett Square, PA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/436,832

(22) Filed: May 13, 2003

Related U.S. Application Data
(63) Continuation-in-part of application No. 10/145,175, filed on May 14, 2002.

(51) Int. Cl. C08L 31/00

(52) U.S. Cl. 525/94

(57) ABSTRACT

An acrylonitrile-butadiene-styrene (ABS) and polycarbonate (PC) blend having improved impact resistance (e.g., increased Izod impact) and improved flow properties (e.g., capillary rheology/shear viscosity) can be achieved by the addition of an ethylene/acrylate ester copolymer (e.g., ethylene/n-butyl acrylate copolymer, ethylene/methyl acrylate copolymer, or the like) or certain functionalized terpolymers thereof (e.g., ethylene/n-butyl acrylate/glycidyl terpolymer, ethylene/n-butyl acrylate/carbon monoxide terpolymer, and the like) to the ABS/PC alloy. The blends exhibiting improved impact resistance characteristics according to the instant invention are particularly useful in diverse applications requiring high impact strength.

### CROSS-REFERENCE TO RELATED APPLICATIONS

This is a continuation-in-part of U.S. application Ser. No. 10/145,175 filed May 14, 2002, herein incorporated by reference.

### BACKGROUND OF THE INVENTION

1. Field of the Invention

The present invention relates to an ethylene/acrylate ester copolymer modified acrylonitrile-butadiene-styrene resin and polycarbonate blend having improved impact resistance. More specifically but not by way of limitation, the present invention relates to the incorporation of an ethylene/acrylate ester copolymer (e.g., ethylene/n-butyl acrylate copolymer, ethylene/methyl acrylate copolymer, or the like) and certain functionalized terpolymers thereof (e.g., ethylene/n-butyl acrylate/glycidyl terpolymer, ethylene/n-butyl acrylate/carbon monoxide terpolymer, and the like) into an acrylonitrile-butadiene-styrene and polycarbonate blend in order to improve Izod impact.

2. Description of the Related Art

It is generally known in the art to employ polycarbonate resins, having excellent physical properties for molded and shaped articles but low thermoplasticity, with certain graft copolymers based on butadiene, acrylonitrile, and styrene to produce blends exhibiting thermoplastic properties (see for example U.S. Pat. No. 3,130,177). It is also known that the impact strength of a high molecular weight polycarbonate can be improved by adding a combination of a methacrylate/acrylate copolymer and an olefin/acrylate copolymer (see U.S. Pat. No. 4,260,693). In U.S. Pat. No. 4,390,657 the use of a multiphase composite interpolymer (as taught in U.S. Pat. No. 4,096,202) involving an acrylate/methacrylate copolymer with a small amount of a third crosslinking monomer and a graftlinking monomer, in the presence of a final rigid thermoplastic phase polymerized in the presence of these, is shown to improve the impact strength of a polycarbonate and acrylonitrile-butadiene-styrene blend. However, the need for further impact improved polycarbonate and acrylonitrile-butadiene-styrene blends still exists.

### BRIEF SUMMARY OF THE INVENTION

In view of the above-mentioned problem, it has now been discovered that the addition or incorporation of an ethylene/acrylate ester copolymer (e.g., ethylene/n-butyl acrylate copolymer, ethylene/methyl acrylate copolymer, ethylene/n-butyl acrylate/glycidyl terpolymer, ethylene/n-butyl acrylate/carbon monoxide terpolymer, and the like) into an acrylonitrile-butadiene-styrene and polycarbonate blend improves Izod impact.

Thus the present invention provides an acrylonitrile-butadiene-styrene resin and polycarbonate blend having improved impact resistance and improved flow properties comprising for every one hundred parts by weight of acrylonitrile-butadiene-styrene resin and polycarbonate blend from one to twenty parts by weight ethylene/acrylate ester copolymer or functionalized terpolymers thereof. Preferably the ethylene/acrylate ester copolymer and functionalized terpolymers thereof are selected from the group consisting of ethylene/n-butyl acrylate copolymer, ethylene/methyl acrylate copolymer, ethylene/n-butyl acrylate/glycidyl terpolymer, ethylene/n-butyl acrylate/carbon monoxide terpolymer and mixtures thereof.

The present invention further provides a method of improving impact resistance and improved flow properties of an acrylonitrile-butadiene-styrene and polycarbonate blend comprising the steps of:

(i) adding for every one hundred parts by weight cumulative of acrylonitrile-butadiene-styrene and polycarbonate from one to twenty parts by weight ethylene/acrylate ester copolymer or functionalized terpolymers thereof; and

(ii) mixing the acrylonitrile-butadiene-styrene, polycarbonate, and ethylene/acrylate ester copolymer or functionalized terpolymers thereof at elevated temperature and high shear rate.

### DETAILED DESCRIPTION OF THE INVENTION

In this disclosure, the term “copolymer” is used to refer to polymers containing two or more monomers. The use of the term terpolymer and/or termonomer means that the copolymer has at least three different comonomers. “Consisting essentially of” means that the recited components are essential, while smaller amounts of other components may be present to the extent that they do not detract from the operability of the present invention. The term “(meth)acrylic acid” refers to methacrylic acid and/or acrylic acid, inclusively. Likewise, the term “(meth) acrylate” means methacrylate and/or acrylate.

The acrylonitrile-butadiene-styrene resins useful in the present invention are generally any such ABS plastics as known in the art. Thus both the polyblend type ABS consisting essentially of a butadiene-based rubber (usually a nitrile rubber) physically dispersed in a styrene/acrylonitrile copolymer as well as the graft-copolymer mix type ABS consisting essentially of a butadiene-based rubber (usually polybutadiene) graft-copolymerized with styrene/acrylonitrile copolymer, along with ungrafted polybutadiene (which is physically dispersed in the styrene/acrylonitrile copolymer) are useful. Preferably, the graft copolymer mixes are used. Typically the ABS graft copolymer mixes involve from 20 to 30 weight percent acrylonitrile, from 20 to 30 weight percent butadiene, and from 40 to 60 weight percent styrene, but individual applications outside these ranges are not uncommon. Such ABS resins can be manufactured by any of the methods generally practiced in the art. As such, light cross-linking (usually effected during the initial polymerization) restricts dissolution of the rubbery phase while graft copolymerization of polybutadiene improves it adhesion to the continuous phase of the copolymer.

It should be further appreciated that other analogous comonomers can be employed including various alkyl (meth)acrylates, dienes, and alkenyl aromatics in combination with or as replacement for one or more of the monomers of the acrylonitrile-butadiene-styrene resin.

The polycarbonate resins useful in the present invention are generally any such high molecular weight aromatic polycarbonate resins known in the art. Such commercial plastics with average molecular weight up to several hundred thousand are readily available. Typically they are prepared from diphenylolalkanes, of which the most common is 2,2-diphenylolpropane or bisphenol-A. Thus the polycarbonate resin may be derived from various dihydric phenols, such as, 2,2-bis(4-hydroxyphenyl) propane, bis(4-hydroxyphenyl) methane, 2,2-bis(4-hydroxy-3-methylphenyl) propane, 4,4-bis(4-hydroxyphenyl) heptane, 2,2-bis(3,5,3′, 5′-tetrachloro-4,4′-dihydroxyphenyl) propane, 2,2-bis(3,5,3′, 5′-tetrabromo-4,4′-dihydroxyphenyl) propane, (3,3′-dichloro-4,4′-dihydroxy-diphenyl) methane, and mixtures thereof. Other dihydric phenols, which are suitable for use in preparation of the polycarbonates, are disclosed in U.S. Pat. Nos. 2,999,835; 3,028,365; 3,334,154; and 4,131,575 (herein incorporated by reference).

Typically these polycarbonates are prepared by ester interchange in a melt of bisphenol-A (or the like) and an organic carbonate (e.g., diphenyl carbonate) under reduced pressure to effect the removal of phenol. Alternatively, a Schotten-Baumann type reaction of bisphenol-A (dissolved in aqueous alkali plus a quaternary ammonium compound) at room temperature with phosgene in the presence of an organic solvent phase can be employed. Also, a homogeneous solution reaction using for example pyridine as both base and solvent may be employed. Other methods for preparation of the polycarbonate can be found in U.S. Pat. Nos. 4,018,750; 4,123,436; 3,153,008 as well as 3,169,131 (herein incorporated by reference).

The ethylene/acrylate ester copolymer useful in the present invention to improve impact resistance is derived from the copolymerization of ethylene and one or more C₁ to C₈ alkyl ester of acrylic acid or methacrylic acid. Typically the ethylene comonomer represents from about 30 to about 95 weight percent of the copolymer with alkyl (meth)acrylate ester comonomer representing the remaining 5 to about 70 weight percent of the copolymer, with the range of 20 to 30 weight percent ethylene particularly preferred. Preferably, the other comonomer is either n-butyl acrylic acid ester or methyl acrylic acid ester with methyl acrylate being the most preferred. Optionally, this ethylene/acrylate ester copolymer can be functionalized by the presence of up to about 15 weight percent of termonomer such as carbon monoxide or an α,β-unsaturated epoxide (e.g., glycidyl acrylate or glycidal methacrylate. Preferably, the functionalized termonomer is either carbon monoxide or glycidyl acrylate present in the range of 3 to 13 or 1.4 to 12 weight percent, respectively.

The ethylene/acrylate ester copolymer and functionalized terpolymer are prepared by free radical initiated copolymerization of the respective comonomers. The copolymerization reaction can be conveniently performed in either a pressurized autoclave type reactor or in a tubular reactor as generally practiced in the art. The ethylene/acrylate ester copolymer use in the present invention is a relative high molecular weight copolymer characterized buy a melt index numerically approaching one and in the case of the tubular reactor an M.I. as low as 0.7 or even 0.5. The amount of ethylene/acrylate ester copolymer employed per one hundred parts by weight cumulative ABS plus PC will range from about 1.0 parts to about 20 parts by weight copolymer. The desired improvement in impact resistance for the resulting blend will be a function of the amount of ethylene/acrylate ester copolymer employed and the relative amount of ethylene and acrylate ester comonomer ratio present in the copolymer. Typically the Izod Impact resistance will be optimized at from 5 to 7 parts by weight copolymer per hundred parts ABS plus PC, with 10 parts by weight copolymer additive being a pragmatic beneficial upper limit. However, with ethylene/acrylate ester copolymer having high acrylate ester content (i.e., greater than 30 weight percent) the improvement in impact resistance will extend to as high as about 20 parts by weight copolymer loading.

The compositions of the present invention are physical blends of ABS, polycarbonate, and an ethylene/acrylate ester copolymer impact modifier. Such blends are prepared from the three polymeric constituents by mixing the three in essentially any order and subjecting the mix to an elevated temperature and high shear. The actual mixing can be achieved by any conventional method. Preferably, the components are mixed in a commercial thermoplastic extruder. Typically the acrylonitrile-butadiene-styrene resin and polycarbonate blend involve from 30 to 70 weight percent ABS and from 70 to 30 weight percent PC, but it is not uncommon to observe improvement in individual properties of starting materials outside these ranges.

In practice, the impact modified blends of the present invention will advantageously contain minor amounts, typically up to a few percent, of other additives such as pigments, coloring agents, carbon black, ultraviolet light stabilizers, antioxidants, processing aids, fiberglass, mineral fillers, anti-slip agents, plasticizers, flame retardants and the like. Various such additives and their respective uses are well known in the art and commercially used in connection with ABS and polycarbonate blend applications.

The following examples are presented to more fully demonstrate and further illustrate various aspects and features of the present invention. As such, the showings are intended to further illustrate the differences and advantages of the present invention but are not meant to be unduly limiting. In presenting the following examples all blends, unless otherwise specified, were extrusion compounded on a ZSK-30 co-rotating twin screw extruder using typically the following temperature profile:

Feed: Cold

Zone 1: 220° C.

Zone 2: 230° C.

Zone 3: 240° C.

Zone 4: 240° C.

Die (Single strand, ¼ inch diameter): 240° C.

Screw Speed: 200 rpm

Output Rate: 15 to 20 lb/hr

Melt Temperature: typically 250 to 270° C.

Test bars (5 inch by ½ inch by ⅛ inch), plaques (8½ inch by ½ inch by ⅛ inch), and disks (3 inch by ⅛ inch) for physical testing were molded using a single screw injection molding machine using typically the following temperature profile and conditions:

Rear: 260° C.

Center: 266° C.

Front: 288° C.

Nozzle: 288° C.

Mold: 93° C.

Ram Speed: Fast

Screw Speed: 55 rpm

Injection Time: 30 seconds

Hold Time: 15 seconds

Back Pressure: 70 psig

Various test conditions for determining physical properties were employed. Tensile and elongation properties were determined according to ASTM D638 using (8½ inch by ½ inch by ⅛ inch) injection molded plaques. The measurements were made on an Instron operated at a crosshead speed of 2 inch/minute at room temperature. Flexural modulus was measured on (5 inch by ½ inch by ⅛ inch) test bars using a 2 inch span, according to ASTM D790 at 0.5 inch/minute and room temperature. Notched Izod impact was determined according to ASTM D256 using (2½ inch by ½ inch by ⅛ inch) bars having a 0.1 inch notch machined into the side of the bar. The bars were derived from a single 5 inch by ½ inch by ⅛ inch molded bar that is then cut into two halves (i.e., one near the gate end and the other is the far end). Shore D hardness was according to ASTM D-2240.

The raw starting materials, their characterization and respective commercial source are summarized as follows:

Magnum® AG700—Acrylonitrile-Butadiene-Styrene (ABS), (Dow Chemical)

Calibre® 201-10—Polycarbonate (PC) (Dow Chemical)

Elvaloy® PTW—Ethylene/n-Butyl Acrylate/glycidyl terpolymer (EnBAGMA) (E.I. du Pont de Nemours & Company)

Elvaloy® HP 4051—Ethylene/n-Butyl Acrylate/Carbon Monoxide terpolymer (EnBACO) (E.I. du Pont de Nemours & Company)

Fusabond® MG 423D; (E.I. du Pont de Nemours & Company)

Elvaloy® 1125 AC—Ethylene/Acrylate copolymer (EMA); 25% MA (E.I. du Pont de Nemours & Company)

Elvaloy® 3427 AC—Ethylene/Acrylate copolymer (EBA); 27% BA (E.I. du Pont de Nemours & Company)

Optema TC221—Ethylene/Acrylate copolymer (EMA)

Evaflex 709—Ethylene/Acrylate copolymer (E/A) (autoclave; MDP, Mitsui/DuPont, Japan)

### EXAMPLE 1

A series of six different blends of acrylonitrile-butadiene-styrene copolymer and polycarbonate was prepared and tested as generally described above. Five of the runs involved either an ethylene/acrylate ester copolymer or corresponding functionalized terpolymer as an impact resistance modifier. Details of the compositions and resulting data are presented in the Table 1. As shown in this table, the addition of 5 weight percent of an ethylene/methyl acrylate copolymer (E/MA; 25 wt % MA) to a 40:60 weight ratio blend of acrylonitrile-butadiene-styrene resin and polycarbonate increased the Izod Impact strength of the blend at 23° C. from 17 ft.lbs/in to 27 ft.lbs/in.

TABLE 1

| | Run | | | | | |
|---|---|---|---|---|---|---|
| | 1 | 2 | 3 | 4 | 5 | 6 |
| Magnum ® AG700 | 40.0% | 38.0% | 38.0% | 38.0% | 38.0% | 45.0% |
| Calibre ® 201-10 | 60.0% | 57.0% | 57.0% | 57.0% | 57.0% | 45.0% |
| Elvaloy ® PTW | 00.0% | 05.0% | | | | |
| Elvaloy ® 3427 | — | — | 5.0% | — | — | — |
| Elvaloy ® 1125 | — | — | — | 5.0% | — | |
| Elvaloy ® HP4051 | — | — | — | — | 5.0% | — |
| Fusabond ® MG423D | | | | | | 10.0% |
| Notched Izod 23° C. (J/m) | 903 | 967 | 763 | 1462 | 875 | 659 |
| (ft-lb/in) | 16.9 | 18.1 | 14.3 | 27.4 | 16.4 | 12.3 |
| Notched Izod 0° C. (J/m) | 736 | 288 | 352 | 970 | 743 | 382 |
| (ft-lb/in) | 13.8 | 5.4 | 6.7 | 18.2 | 13.9 | 7.12 |
| Flex Modulus (Mpa) | 3078 | 2589 | 2696 | 2964 | 2655 | 2406 |
| HDT @ 264 psi (° C.) | 100.4 | 100.1 | 98.3 | 100.3 | 99.5 | 90.3 |
| Shore D Avg. Hard. | 75.7 | 71.6 | 73.1 | 76.3 | 78.7 | 76.6 |

### EXAMPLE 2

In a manner analogous to Example 1, a series of nine additional blends of ABS/PC alloy and PC modified with five weight percent ethylene/acrylate copolymer impact additive was prepared and tested. Run 1 was a blend of 40 weight percent ABS polymer (Magnum AG 700 supplied by Dow Chemical) and 60 weight percent PC polymer (Calibre 210-10 supplied by Dow Chemical). Run 2 through 6 were blends of the same ABS and PC polymers containing 5 weight percent of an ethylene/acrylate copolymer impact additive. Run 7 through 9 involved 95 weight percent of the PC polymer with 5 weight percent of the ethylene/acrylate copolymer impact additive. Details of the compositions and resulting data are presented in the Table 2.

TABLE 2
Impact Modified ABS/PC alloy and PC

| | Run# | | | | | | | | |
|---|---|---|---|---|---|---|---|---|---|
| | 1 | 2 | 3 | 4 | 5 | 6 | 7 | 8 | 9 |
| Magnum AG700 | 40 | 38 | 38 | 38 | 38 | 38 | | | |
| (ABS) | | | | | | | | | |
| Calibre 201-10 | 60 | 57 | 57 | 57 | 57 | 57 | 95 | 95 | 95 |
| (PC) | | | | | | | | | |
| Elvaloy ® 4051 | | 5 | | | | | 5 | | |
| Elvaloy ® 1125AC | | | 5 | | | | | 5 | |
| Elvaloy ® 3427AC | | | | 5 | | | | | |
| Optema TC221 | | | | | 5 | | | | |
| Evaflex 709 | | | | | | 5 | | | |
| Evaloy ® PTW | | | | | | | | | 5 |
| Notched Izod | | | | | | | | | |
| ¼″ | | | | | | | | | |
| 23° C. | | | | | | | | | |
| J/m | 647 | 1151 | 927 | 737 | 896 | 774 | 759 | 889 | 692 |
| ft-lb/in | 12.1 | 21.6 | 17.4 | 13.8 | 16.8 | 14.5 | 14.2 | 16.7 | 13.0 |
| 0° C. | | | | | | | | | |
| J/m | 549 | 879 | 747 | 460 | 602 | 465 | 700 | 745 | 660 |
| ft-lb/in | 10.3 | 16.5 | 14 | 8.6 | 11.3 | 8.7 | 13.1 | 14.0 | 12.4 |
| Notched Izod | | | | | | | | | |
| ⅛″ | | | | | | | | | |
| 23° C. | | | | | | | | | |
| J/m | 817 | 1226 | 1139 | 690 | 871 | 659 | 825 | 864 | 841 |
| ft-lb/in | 15.3 | 23.0 | 21.3 | 12.9 | 16.3 | 12.4 | 15.5 | 16.2 | 15.8 |
| 0° C. | | | | | | | | | |
| J/m | 652 | 852 | 669 | 266 | 341 | 309 | 791 | 787 | 766 |
| ft-lb/in | 12.2 | 16.0 | 12.5 | 5.0 | 6.4 | 5.8 | 14.8 | 27.2 | 14.4 |
| Tensile Strength | 8015 | 7191 | 7342 | 7202 | 7351 | 7220 | 8680 | 8411 | 9239 |
| psi | | | | | | | | | |
| Break Stress psi | 6807 | 6455 | 7159 | 5708 | 6007 | 5596 | 8666 | 8409 | 9239 |
| % Elongation @ | 69 | 120 | 130 | 38 | 53 | 37 | 110 | 110 | 130 |
| Break | | | | | | | | | |

### EXAMPLE 3

In order to evaluate the improved flow properties associated with the use of impact additive, a series of twelve runs were performed using two different grades of acrylonitrile-butadiene-styrene copolymer and polycarbonate modified cm ethylene/methyl acrylate copolymer additive. Melt viscosity was determined at 300° C. using a capillary length of 30 mm and capillary diameter of 1 mm. Runs 1, 4, and 7 were blends of ABS and PC without additive while runs 2, 3, 5, 6 and 8 were blends of ABS and PCT with EMA copolymer additive. The final four runs 9-12 were the individual ABS and PC polymer alone. The details and resulting data are presented in Table 3.

TABLE 3

| | RUN | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Chei Mei 7025IR | 60% | 38 | 38 | 30 | 28 | 27 | | | 100 | | | |
| ABS | | | | | | | | | | | | |
| Magnum ® | | | | | | | 60 | 38 | | 100 | | |
| AG700 | | | | | | | | | | | | |
| Mitsubishi 757 | 40 | 57 | 54 | 70 | 66 | 63 | | | | | 100 | |
| PC | | | | | | | | | | | | |
| Calibre ® 201-10 | | | | | | | 40 | 57 | | | | 100 |
| Elvaloy ® 1125 | | 5 | 10 | | 5 | 10 | | 5 | | | | |
| AC | | | | | | | | | | | | |

CAPILLARY RHEOLOGY (Shear Viscosity, Pa*Sec) @ 300° C. vs. (Shear Rate, Sec⁻¹)

| | | | | | | | | | | | | |
|---|---|---|---|---|---|---|---|---|---|---|---|---|
| Rate (1/s) | | | | | | | | | | | | |
| 3003.8 | 79.1 | 69.4 | 64.4 | 80.2 | 77.9 | 74.8 | 69.8 | 64.1 | 64.5 | 55.5 | 270.9 | 249 |
| 1605.3 | 112 | 99.2 | 88.5 | 114.5 | 111.5 | 106.4 | 100.4 | 93.2 | 94 | 84.7 | 389.9 | 352.2 |
| 997.2 | 140.4 | 126.3 | 112.4 | 146 | 140.4 | 134.8 | 131.5 | 120.1 | 127.6 | 115.3 | 487.6 | 435.7 |
| 498.6 | 182.4 | 168.6 | 153.9 | 193.8 | 193.1 | 179.6 | 181.2 | 166.3 | 192.4 | 178.4 | 615.3 | 537.1 |
| 255.4 | 233.1 | 211.3 | 214 | 240 | 243.6 | 230 | 235.4 | 225.4 | 285.1 | 271.8 | 695.3 | 615.6 |
| 97.3 | 306 | 296.4 | 291.7 | 316.8 | 328.7 | 316.8 | 327.5 | 326.3 | 498.4 | 462.6 | 782.9 | 706.4 |
| 48.6 | 353.8 | 387.3 | 348.9 | 375.3 | 399.2 | 404 | 401.6 | 394.4 | 762.6 | 710 | 855.8 | 808 |
| 997.2 | 137.5 | 126.3 | 125.8 | 149.5 | 141.3 | 137 | 130.7 | 122.7 | 130.4 | 115.7 | 487.9 | 441.4 |

Having thus described and exemplified the invention with a certain degree of particularity, it should be appreciated that the following claims are not to be so limited but are to be afforded a scope commensurate with the wording of each element of the claim and equivalents thereof.

I claim:

1. An acrylonitrile-butadiene-styrene and polycarbonate blend having improved impact resistance and improve flow properties comprising for every one hundred parts by weight of acrylonitrile-butadiene-styrene and polycarbonate blend from one to twenty parts by weight ethylene/acrylate ester copolymer or functionalized terpolymer thereof.

2. An acrylonitrile-butadiene-styrene and polycarbonate blend of claim 1 wherein said ethylene/acrylate ester copolymer and functionalized terpolymers thereof are selected from the group consisting of ethylene/n-butyl acrylate copolymer, ethylene/methyl acrylate copolymer, ethylene/n-butyl acrylate/glycidyl terpolymer, ethylene/n-butyl acrylate/carbon monoxide terpolymer and mixtures thereof.

3. An acrylonitrile-butadiene-styrene and polycarbonate blend of claim 1 wherein said ethylene/acrylate ester copolymer comprises from 30 to 95 weight percent ethylene comonomer and from 70 to 5 weight percent acrylate ester comonomer and said functionalized terpolymer thereof comprises up to 15 weight percent carbon monoxide termonomer or an α,β-unsaturated epoxide termonomer.

4. An acrylonitrile-butadiene-styrene and polycarbonate blend of claim 2 wherein said ethylene/acrylate ester copolymer comprises from 30 to 95 weight percent ethylene comonomer and from 70 to 5 weight percent acrylate ester comonomer and said functionalized terpolymer thereof comprises from 3 to 13 weight percent carbon monoxide termonomer or from 1.4 to 12 weight percent glycidyl acrylate termonomer.

5. A method of improving impact resistance and improving flow properties of an acrylonitrile-butadiene-styrene and polycarbonate blend comprising the steps of:
(i) adding for every one hundred parts by weight cumulative of acrylonitrile-butadiene-styrene and polycarbonate from one to twenty parts by weight ethylene/acrylate ester copolymer or functionalized terpolymers thereof; and
(ii) mixing said acrylonitrile-butadiene-styrene, polycarbonate, and ethylene/acrylate ester copolymer or functionalized terpolymers thereof at elevated temperature and high shear rate.

6. A method of claim 5 wherein said ethylene/acrylate ester copolymer and functionalized terpolymers thereof selected from the group consisting of ethylene/n-butyl acrylate copolymer, ethylene/methyl acrylate copolymer, ethylene/n-butyl acrylate/glycidyl terpolymer, ethylene/n-butyl acrylate/carbon monoxide terpolymer and mixtures thereof.
